(19) United States
(12) Patent Application Publication
(10) Pub. No.: US 2013/0326240 A1
(43) Pub. Date: Dec. 5, 2013

(54) HOST DEVICE WITH INSTALLABLE POWER SUPPLY

(71) Applicant: MULTI-EXPANDER TECHNOLOGY INC., New Taipei City (TW)

(72) Inventor: Tang-Hsien HUANG, Taipei City (TW)

(73) Assignee: MULTI-EXPANDER TECHNOLOGY INC., New Taipei City (TW)

(21) Appl. No.: 13/711,168

(22) Filed: Dec. 11, 2012

(30) Foreign Application Priority Data
Jun. 4, 2012 (TW) 101210744

(51) Int. Cl. G06F 1/26

(52) U.S. Cl. CPC G06F 1/26
USPC 713/300

(57) ABSTRACT

A host device with an installable power supply comprises: a casing which is a case with an installation space enclosed inside, and the installation space is partitioned into at least a power supply installation space and a plurality of uninterruptible power supply (UPS) installation spaces disposed adjacent to the power supply installation space; a power distribution board installed in the casing, and having an end extended to a junction of the power supply installation space and the UPS installation space, and the power distribution board further has a plurality of charging circuit boards; a power supply detachably coupled to the power distribution board; and a plurality of uninterruptible power supplies detachably coupled to the charging circuit board on the power distribution board.

### CROSS-REFERENCE TO RELATED APPLICATION

This application claims the benefit under 35 U.S.C. §119 of Taiwanese Patent Application No. 101210744, filed Jun. 4, 2012, which is hereby incorporated by reference in its entirety.

### BACKGROUND

1. Field of the Invention

The present invention relates to a host device with an installable power supply, more particularly to the host device having a detachable power supply and the host device can be expanded according to power consumption requirements.

2. Background of the Invention

As science and technology advances, computer systems with high-efficiency computing and processing functions becomes a necessary tool in our daily life and in work, and it is a popular trend of using the computer systems for the purposes of handling business matters or engineering computations.

In general, a computer system comprises a motherboard for managing the system computation function, a hard disk for controlling the data storage, and a power supply for supplying the required system power, and an uninterruptible power supply (UPS).

It is an important issue whether the computer system is equipped with sufficient power supply, but most of the present existing power supplies installed in chassis devices are regularized and without interchangeability, so that the power supply may not be sufficient for a high-efficiency host system, and users have to spend much effort to replace the power supply with another power supply of a higher capacity, or while hoping for a longer power duration of the UPS, it is still necessary to spend time and effort to replace it. Obviously, the inconvenient conventional design is inconvenient and still requires improvements in actual applications.

### BRIEF SUMMARY

In view of the drawbacks of the prior art, the inventor of the present invention designed a host device with an installable power supply to overcome the drawbacks of the prior art and to improve industrial applications.

To achieve the foregoing objective, the present invention provides a technical measure and a design of a host device with an installable power supply, comprising:

a casing, being a case with an installation space enclosed therein, and the installation space being partitioned into at least a power supply installation space and a plurality of UPS installation spaces, and the UPS installation spaces disposed adjacent to the power supply installation space; a power distribution board, installed in the casing, and having an end extended to a junction of the power supply installation space and the UPS installation space, and the power distribution board further including a plurality of charging circuit boards; a power supply, detachably coupled to the power distribution board; and a plurality of uninterruptible power supplies, detachably coupled to the charging circuit board on the power distribution board.

Wherein, the power supply installation space is a slot concavely formed in a direction from the rear of the casing towards the interior of the casing, and the UPS installation spaces are parallel slots concavely formed in a direction from the front of the casing towards the interior of the casing; and the power supply has a shape that is matched with the power supply installation space and is selectively inserted into the power supply installation space of the casing; and the UPS has a shape that is matched with the UPS installation space and is selectively inserted into the UPS installation space of the casing.

Wherein, the charging circuit board is vertically installed onto the power distribution board; the casing is in a rectangular shape; and the casing is further partitioned into a motherboard installation space and a storage device installation space. The host device with an installable power supply further comprises a motherboard, which is a main circuit board installed in the motherboard installation space inside the casing and electrically coupled to the power distribution board; and at least one storage unit which is at least one hard disk installed in the storage device installation space inside the casing and electrically coupled to the motherboard.

The host device with an installable power supply of the present invention adopts a new design of configuration to provide a way of connecting the power supply and the UPS by plugging and unplugging them in the casing of the host device, so as to selectively set the best layout according to the voltage required by the system inside the casing without having to worry about insufficient or unstable system voltage caused by excessive built-in electronic devices.

With the feature of expandable capacity of the UPS, the requirement for extending the time of the USP can be satisfied.

### BRIEF DESCRIPTION OF THE DRAWINGS

FIG. 1 is a top view, showing the layout of a host device with an installable power supply in accordance with the present invention;

FIG. 2 is a side view, showing the layout of a host device with an installable power supply in accordance with the present invention;

FIG. 3 is schematic perspective view of a host device with an installable power supply in accordance with the present invention; and

FIG. 4 is a partial schematic view, of the components of a host device with an installable power supply in accordance with the present invention.

### DETAILED DESCRIPTION

The technical characteristics, contents, advantages and effects of the present invention will be apparent with the detailed description of a preferred embodiment accompanied with related drawings as follows. It is noteworthy that the drawings are not necessarily drawn according to the exact proportion or the actual installation since they are provided for the purpose of illustrating the present invention, but not intended for limiting the scope of the invention.

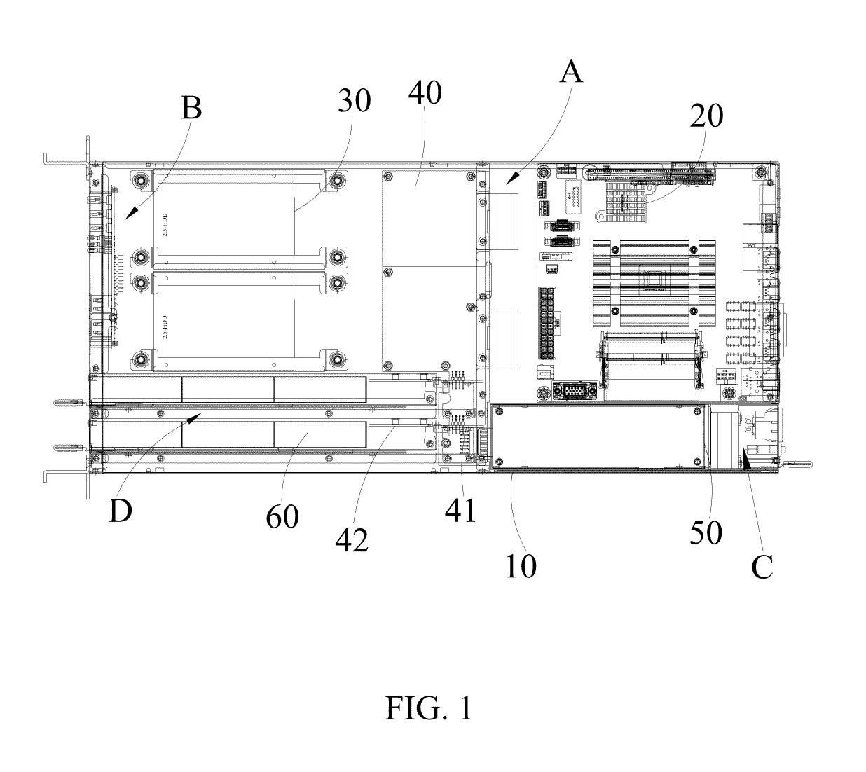

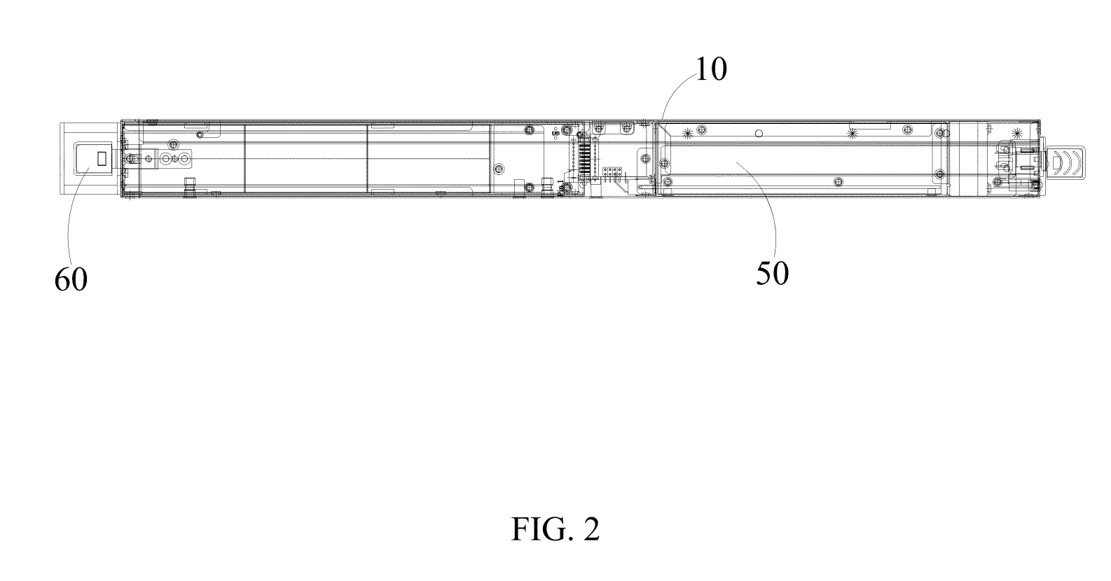

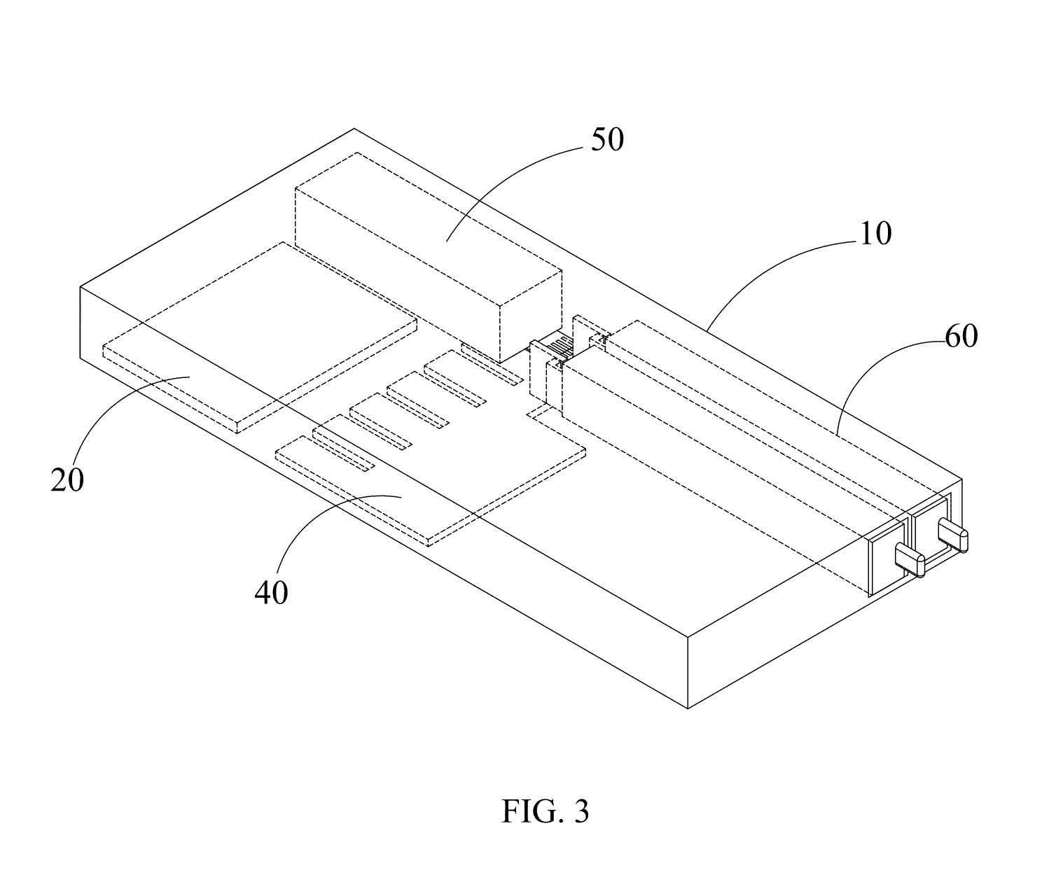

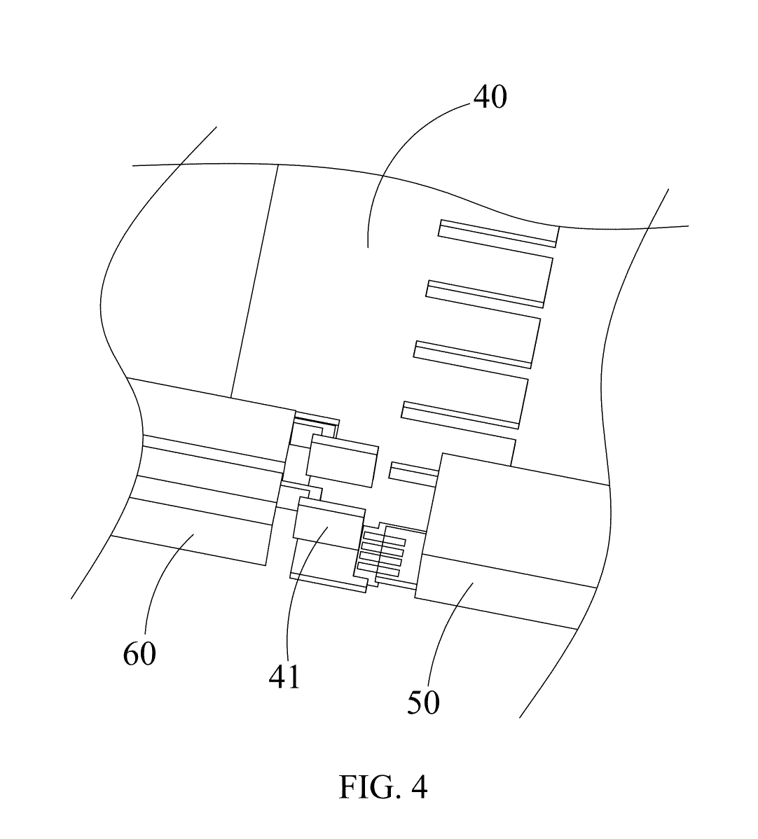

With reference to FIGS. 1 to 4 for a host device with an installable power supply in accordance with a preferred embodiment of the present invention, the host device with an installable power supply comprises a casing (10), a motherboard (20), at least one storage unit (30), a power distribution board (40), a power supply (50) and a plurality of uninterruptible power supplies (UPS) (60).

The casing (10) is a case with an installation space enclosed therein; the casing (10) can be in a rectangular shape; and the installation space can be partitioned into a motherboard installation space (A), a storage device installation space (B), a power supply installation space (C) and a plurality of UPS installation spaces (D), wherein the power supply installation space (C) can be a slot concavely formed in a direction from the rear of the casing (10) towards the interior of the casing (10), and the UPS installation spaces (D) are parallel slots concavely formed in a direction from the front of the casing (10) towards the interior of the casing (10) and corresponding to the power supply installation space (C).

The motherboard (20) is a main circuit board with circuit operating units including a processor, a memory and a display processing circuit installed thereon, and the motherboard (20) is installed in the motherboard installation space (A) inside the casing (10).

The storage unit (30) can be one or more hard disks installed in the storage device installation space (B) inside the casing (10) and electrically coupled to the motherboard (20).

The power distribution board (40) is installed in the casing (10) and electrically coupled to the motherboard (20), and has an end extended to a junction of the power supply installation space (C) and the UPS installation space (D). In addition, the power distribution board (40) further includes a charging circuit board (41), and the power distribution board (40) can be vertically installed on the power distribution board (40). Further, the power distribution board (40) includes a battery safety management unit (42) installed thereon for controlling the switching between direct current and alternate current to manage AC power and DC modules by intelligent management peripherals.

The power supply (50) has a shape matching with the power supply installation space (C) and is selectively inserted into the power supply installation space (C) of the casing (10) to plug onto the power distribution board (40) to supply electric power.

The UPS (60) has a shape matching with the UPS installation space (D) and is selectively inserted into the UPS installation space (D) of the casing (10) to plug into the charging circuit board (41) on the power distribution board (40), so as to receive the electric power for charging, and the UPS (60) is provided as a source of backup power when the power supply (50) fails.

With the skillful design of the host device with an installable power supply of the present invention, the configuration can be changed to provide a way of connecting the power supply (50) and the UPS (60) by plugging and unplugging them on the host casing, so as to selectively set the best layout according to the voltage required by the system inside the casing without having to worry about insufficient or unstable system voltage caused by excessive built-in electronic devices. With the feature of the expandable capacity of the UPS (60), the requirement for extending the time of the USP can be satisfied. Obviously, the present invention improves over the prior art.

While the invention has been described by means of specific embodiments, numerous modifications and variations could be made thereto by those skilled in the art without departing from the scope and spirit of the invention set forth in the claims.

What is claimed is:

1. A host device with installable power supply, comprising:
a casing, being a case with an installation space enclosed therein, and the installation space being partitioned into at least a power supply installation space and a plurality of uninterruptible power supply (UPS) installation spaces disposed adjacent to the power supply installation space;
a power distribution board, installed in the casing, and having an end extended to a junction of the power supply installation space and the UPS installation space, and the power distribution board further having a plurality of charging circuit boards;
a power supply, detachably coupled to the power distribution board; and
a plurality of uninterruptible power supplies (UPS), detachably coupled to the charging circuit board on the power distribution board.

2. The host device with installable power supply of claim 1, wherein the power supply installation space is a slot concavely formed in a direction from the rear of the casing towards the interior of the casing, and the UPS installation spaces are parallel slots concavely formed in a direction from the front of the casing towards the interior of the casing, and the power supply has a shape matched with the power supply installation space and is selectively inserted into the power supply installation space of the casing; and the UPS has a shape matched with the UPS installation space and is selectively inserted into the UPS installation space of the casing.

3. The host device with installable power supply of claim 2, wherein the charging circuit board is vertically installed onto the power distribution board.

4. The host device with installable power supply of claim 3, wherein the power distribution board further includes a battery safety management unit installed thereon.

5. The host device with installable power supply of claim 4, wherein the casing is in a rectangular shape.

6. The host device with installable power supply of claim 5, wherein the casing is further partitioned into a motherboard installation space and a storage device installation space.

7. The host device with installable power supply of claim 6, further comprising a motherboard which is a main circuit board installed in the motherboard installation space inside the casing and electrically coupled to the power distribution board; and at least one storage unit which is at least one hard disk installed in the storage device installation space inside the casing and electrically coupled to the motherboard.
